(19) United States
(12) Patent Application Publication
(10) Pub. No.: US 2023/0010320 A1
(43) Pub. Date: Jan. 12, 2023

(54) CLASSIFICATION AND INDICATING OF EVENTS ON AN EDGE DEVICE

(71) Applicants: Getac Technology Corporation, Taipei City (TW); WHP Workflow Solutions, Inc., North Charleston, SC (US)

(72) Inventors: Thomas GUZIK, Edina, MN (US); Muhammad ADEEL, Edina, MN (US)

(21) Appl. No.: 17/373,091

(22) Filed: Jul. 12, 2021

(51) Int. Cl. H04N 7/18; H04L 29/06

(52) U.S. Cl. CPC H04N 7/188; H04N 7/183; H04L 63/302; H04L 65/608

(57) ABSTRACT

Described herein are techniques that may be used to identify and indicating events within a media content file. Such techniques may comprise receiving a media content having been collected by a media collection device as well as receiving sensor data corresponding to the media content. The techniques may further comprise determining, based on the received sensor data, at least one event to be associated with the media content, generating at least one event indicator to be associated with the media content based on the determined at least one event, and providing the media content and the at least one event indicator to a recipient computing device.

### BACKGROUND

In recent years, a number of events have highlighted the need for increased recordkeeping for law enforcement officers. This need pertains to evidentiary collection as well as protecting the public from potential abuses by a police officer and protecting the police officer from false accusations of abuse. Law enforcement has previously used various camera devices, such as patrol vehicle cameras and body mounted cameras, as a means of reducing liability and documenting evidence. However, media content (e.g., video or images) captured using such camera devices may be reviewed years after the media content was captured. The reviewer may not have an exact date or time for certain events that the reviewer may be interested in. This often results in the reviewer having to spend a significant amount of time reviewing unrelated portions of video in order to find and view portions of the video that he or she is interested in viewing.

### SUMMARY

Techniques are provided herein for identifying and indicating events within a media content file (e.g., a video or audio file) at an edge device for processing by a media processing platform. Media content files may be received at an edge device to be conveyed to a media processing platform from one or more remote media collection devices. Examples of such remote media collection devices may include a wearable device (such as a body-mounted camera) or a vehicle-mounted camera. The edge device may further receive sensor data that corresponds to the received media content file. For example, the edge device may receive sensor data obtained from an accelerometer, gyroscope, compass, or other sensor device. The sensor data may be used to identify an event associated with the received media content based on one or more patterns determined within that sensor data. Once one or more events have been identified, an event indicator may be generated for each of the identified events. Event indicators may then be appended to (or otherwise associated with) the media content file that is provided to the media processing platform. In some embodiments, a viewer can easily locate the associated events within the media content file using such event indicators.

In one embodiment, a method is disclosed as being performed by an edge device, the method comprising receiving a media content having been collected by a media collection device, receiving sensor data corresponding to the media content, determining, based on one or more data patterns detected within the received sensor data, at least one event corresponding to the one or more data patterns to be associated with the media content, generating at least one event indicator to be associated with the media content based on the determined at least one event, and providing the media content and the at least one event indicator to a media processing platform.

An embodiment is directed to a computing device comprising: a processor; and a memory including instructions that, when executed with the processor, cause the computing device to receive a media content having been collected by a media collection device, receive sensor data corresponding to the media content, determine, based on one or more data patterns detected within the received sensor data, at least one event corresponding to the one or more data patterns to be associated with the media content, generate at least one event indicator to be associated with the media content based on the determined at least one event, and provide the media content and the at least one event indicator to a media processing platform.

An embodiment is directed to a non-transitory computer-readable media collectively storing computer-executable instructions that upon execution cause one or more computing devices to perform acts comprising receiving a media content having been collected by a media collection device, receiving sensor data corresponding to the media content, determining, based on one or more data patterns detected within the received sensor data, at least one event corresponding to the one or more data patterns to be associated with the media content, generating at least one event indicator to be associated with the media content based on the determined at least one event, providing the media content and the at least one event indicator to a media processing platform.

The foregoing, together with other features and embodiments, will become more apparent upon referring to the following specification, claims, and accompanying drawings.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates a computing environment in which media content generated by one or more media collection devices is indicated by an edge device to be maintained in accordance with at least some embodiments;

FIG. 2 is a block diagram showing various components of a computing system architecture that supports a classification and indicating of events within media content in accordance with some embodiments;

FIG. 3 depicts a block diagram showing an example process flow for identifying and indicating events within media content via one or more edge devices in accordance with embodiments;

FIG. 4 depicts an example structure diagram for a media content file that may be generated to include indicated events in accordance with at least some embodiments;

FIG. 5 depicts an example of a graphical representation of one or more interactions that may be undertaken with a media content file that has been indicated with one or more events in accordance with embodiments;

FIG. 6 depicts an illustrative example of a number of interactions that may take place in accordance with at least some embodiments;

FIG. 7 depicts a block diagram showing an example process flow for automatically identifying and indicating events in a media content in accordance with embodiments; and

FIG. 8 illustrates an exemplary overall training process of training a machine learning model in accordance with aspects of the disclosed subject matter.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Described herein are techniques that may be used to automatically identify and generate event indicators corresponding to events within a media content file that are obtained from a media collection device. In some embodiments, sensor data is received at an edge device along with media content to be conveyed to a media processing platform. The sensor data is received from the same media collection device from which the media content is received. The sensor data may be provided to a trained machine learning model in order to identify one or more data patterns that correspond to an event. Upon identifying such an event, an event indicator may be generated that corresponds to the event. The generated event indicator may then be associated with the media content (e.g., within an event track). An event indicator may be any suitable sign, token, or indication of an event related to a point in time and a media content data file. One or more procedural rules may then be applied during processing of the media content based on the event indicators associated with that media content.

When a body camera is used to continuously capture video data (e.g., within a blackbox), that video data may become hard to analyze using conventional systems. In order to identify a particular portion of the video that is of interest to a user (e.g., a reviewer), that user may have to review a large section (potentially hours) of video imagery. Even if the user views this imagery at an increased speed, this can be a huge drain on resources.

Embodiments of the disclosure provide several advantages over conventional techniques. For example, embodiments of the proposed system provide for automatic identification and indicating of events within media content. This allows an interested party to skip to relevant portions of a video or other media file without having to review the media file in its entirety. Additionally, because events are identified from sensor data that accompanies the media file, the media file can be enhanced to include information/context that would otherwise not be available from simple review of the media file. Furthermore, the system enables portions of a media file to be flagged for review based on a detected event type, eliminating the necessity to review an entire media file, which can be invasive and time consuming, especially in the case that the media file is generated via a body camera. Additionally, embodiments of the disclosure provide for the ability to more easily identify media content that may need to be reviewed by a reviewer, which may be more productive than systems that rely upon random review of media content.

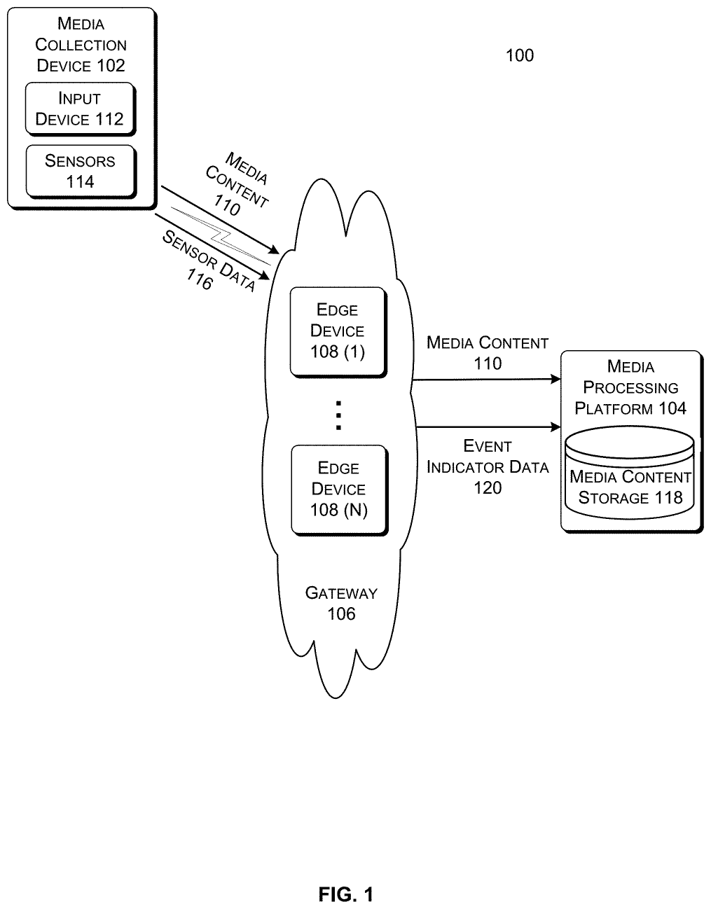

FIG. 1 illustrates a computing environment in which media content generated by one or more media collection devices is indicated by an edge device to be maintained in accordance with at least some embodiments. As depicted in FIG. 1, a computing environment 100 may include one or more media collection devices 102 configured to communicate with a media processing platform 104 via a gateway 106. Such a gateway may comprise a number of edge devices 108 configured to receive media content 110 from the media collection device and to convey at least a portion of that received media content 110 to the media processing platform.

In the computing environment depicted in FIG. 1, a media collection device 102 may comprise any suitable electronic device capable of being used to collect media content related to an environment surrounding the media collection device. In some cases, the media collection device may be a camera mounted within a vehicle. In some cases, the media collection device may be a device that is capable of being worn or otherwise mounted or fastened to a person. The media collection device 102 may include at least one input device 112, such as a microphone or camera, and a number of sensors 114 capable of obtaining information about a status of the media collection device. In some embodiments, the number of sensors 114 may include a temperature sensor, a real-time clock (RTC), an inertial measurement unit (IMU), or any other suitable sensor. An IMU may be any electronic device that measures and reports a body's specific force, angular rate, and sometimes the orientation of the body, using a combination of accelerometers, gyroscopes, and magnetometers.

The media collection device may be configured to transmit data to the media processing platform 104. More particularly, the media collection device may be configured to transmit media content 110 captured by the input device to the media processing platform via a communication session established over a gateway. Media content 112 may comprise any suitable series of data samples collected via any suitable type of input device. For example, the media collection device may be configured to transmit streaming video and/or audio data to the media processing platform. In another example, the media collection device may be configured to transmit still images captured at periodic intervals. In some embodiments, the media collection device may be further configured to transmit sensor data 116 captured by the one or more sensors 114 to the media processing platform. Sensor data 114 may include any suitable data collected in relation to environmental factors affecting the media collection device. For example, the media collection device may sensor data 114 about movements and/or orientations of the media collection device. Such sensor data may be transmitted as associated with the media content (e.g., as metadata) or separate from the media content. Each of the media content and sensor data may include timestamp information that may be used to correlate the two types of data.

The media processing platform 104 can include any computing device configured to perform at least a portion of the operations described herein. Media processing platform 104 may be composed of one or more general purpose computers, specialized server computers (including, by way of example, PC (personal computer) servers, UNIX™ servers, mid-range servers, mainframe computers, rack-mounted servers, etc.), server farms, server clusters, or any other appropriate arrangement and/or combination. Media processing platform 104 can include one or more virtual machines running virtual operating systems, or other computing architectures involving virtualization such as one or more flexible pools of logical storage devices that can be virtualized to maintain virtual storage devices for the computer. In some embodiments, the media processing platform may maintain media content received from one or more media collection devices within a media data storage 118.

An edge device 108 may include any suitable computing device capable of performing at least a portion of the functions described herein. In some embodiments, each of the edge devices may act, either individually or in unison, as a gateway that conveys information between one or more media collection devices and the media processing platform. In some embodiments, a number of edge devices may form a distributed computing environment (e.g., a cloud computing environment). In some embodiments, an edge device may comprise a mobile or portable computing device. For example, an edge device may comprise a computing device installed within a vehicle. In some cases, an edge device may use multiple communication channels when communicating with different electronic devices. For example, the edge device may communicate with one or more media collection devices via a short-range communication channel and with the media processing platform via a long-range communication channel.

In accordance with at least some embodiments, the edge device may be configured to receive sensor data 116 from the media collection device in addition to receiving media content 110. The edge device may be further configured to categorize and identify one or more events associated with the media content based on the received sensor data. In some embodiments this may comprise using one or more trained machine learning models to perform such categorization and identification. Event indicator data 120 corresponding to identified events in the media content may be provided by the edge device to the media processing platform in association with the media content 110. The media processing platform may then apply one or more procedures to the media content based on the received event indicator data.

For illustration purposes, consider a scenario in which an edge device is a computing device installed within a vehicle and a media collection device is a body-mounted camera worn by an operator in close proximity to the vehicle. In some cases, it may be in the best interests of the law enforcement office to issue to its officers body-mounted cameras that constantly collect media content (e.g., the wearer is unable to prevent collection of data). While these body-mounted camera devices may include a record button, that button may not actually prevent the collection of media content using the device. In this scenario, the body-mounted camera device may transmit information to an edge device installed within the officers' vehicle via a communication session established over a short-range communication channel. Particularly, the body-mounted camera device may collect video and transmit that video to the edge device along with positional information received from one or more sensors installed in the body-mounted camera device. The positional information may indicate a change in position or orientation of the body-mounted camera device.

Continuing with the above scenario, the body-mounted camera may continue to collect and transmit media content to the edge device installed within the vehicle while the body-mounted camera is in operation. In this scenario, the law enforcement officer may, while operating the body-mounted camera, begin to run. Information from accelerometers and/or other sensors may be transmitted to the edge device along with the media content. The edge device may then interpret the sensor information to make a determination that the officer has begun to run. In this scenario, the edge device may generate an event associated with the officer's running, which may then be indicated into the collected video when it is provided to the media processing platform. Additionally, subsequent to the officer beginning to run, the officer may press a record button on the image capture device. The pressing of this button, which may result in additional sensor information, may then cause the edge device to generate a second event associated with the pressing of that button. Upon receiving the event indicators related to the officer's running and the pressing of the record button, the media processing platform may determine a ranking value for the video based on the indicated events. Based on that ranking value, a determination may be made that the collected video should be provided to a reviewer. In some embodiments, the video may be provided to a reviewer in real-time (e.g., as the video is collected), allowing the reviewer to be apprised of the event as it occurs.

Upon receiving the information from the body-mounted camera device, the edge device may be configured to correlate patterns of data to particular events captured by the body camera/media collection device. For example, this may comprise identifying particular patterns of movements attributed to the media collection device from the sensor data. In another example, this may comprise identifying particular objects or types of objects that are depicted within the received media content 110 (e.g., using one or more object recognition techniques). In another example, this may comprise identifying particular audio cues (e.g., spoken words or phrases) within the media content. Each event may be classified based on a type associated with that event. The edge device may then generate, for each identified event, an event indicator that corresponds to that event and the media content. In some embodiments, the event indicator is appended to the media content itself (e.g., as metadata). In some embodiments, the event indicator is appended to a reference database table or other suitable mapping between the media content and the corresponding identified events. In these embodiments, each event may be mapped to a timestamp within the media content or a range of times during which the event is determined to have occurred.

The edge device then transmits this event indicator data, along with the streaming video, to the media processing platform to be processed. In this scenario, the edge device may transmit information to the media processing platform via a communication session established over a long-range communication channel. For example, the edge device may establish communication with the media processing platform via a cellular network.

The media processing platform may store the received media content. The media content can be stored either separate from the provided event indicator data (e.g., in separate storage) or as indicated media content. When the media content is presented to a user, that user may also be presented with an indication of the events identified in relation to the indicated media content as well as a time corresponding to each of those events. For example, upon selecting a video to view, a user may be provided with a list of each of the events determined to be depicted within that video as well as times within the video at which those events occur. In some embodiments, the user may be provided the ability to click on (or otherwise select) a particular event and have the video being playing from a time corresponding to that event.

In some embodiments, the event indicator data may be used to identify procedural rules (e.g., data retention rules/storage rules) to be applied to portions of the media content. For example, portions of the media content associated with specific event types may be stored for a longer period of time than portions of media content associated with different event types and/or portions of the media content that are not associated with an event type. In some embodiments, the event indicator data may be used to identify media content, or at least a portion thereof, to be reviewed by a reviewer. In some embodiments, a ranking value or score may be calculated for each media content or portion thereof based on the event types associated with it. In some embodiments, the ranking value may be compared to a predetermined threshold ranking value. In these embodiments, if the ranking value is greater than the predetermined threshold ranking value, then the media content may be provided to a reviewer to be reviewed.

In some embodiments, communication between one or more components as described with respect to the computing environment 100 can be facilitated via a network. Such a network can include any appropriate network, including an intranet, the Internet, a cellular network, a local area network or any other such network or combination thereof. Components used for such a system can depend at least in part upon the type of network and/or environment selected. Protocols and components for communicating via such a network may be known to one skilled in the art and will not be discussed herein in detail. Communication over the network can be enabled by wired or wireless connections and combinations thereof.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

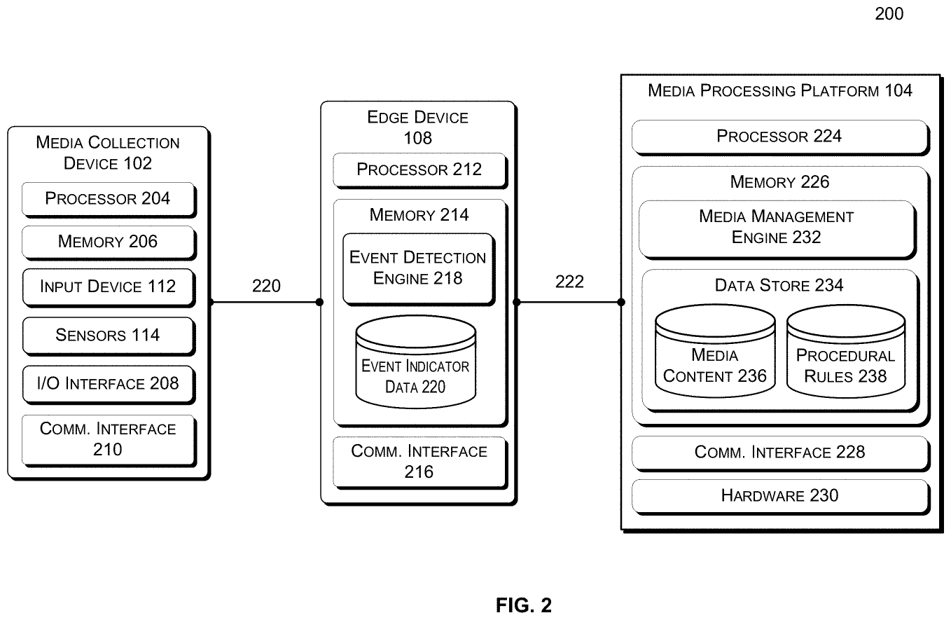

FIG. 2 is a block diagram showing various components of a computing system architecture that supports a classification and indicating of events within media content in accordance with some embodiments. The system architecture 200 may include a one or more media collection devices 102, a media processing platform 104 that comprises one or more computing devices, and at least one edge device 108 configured to facilitate communications between the media collection device and the media processing platform.

A media collection device 102 may be any suitable electronic device capable of obtaining and recording situational data and that has communication capabilities. The types and/or models of media collection device may vary. The media collection device may include at least a processor 204, a memory 206, an input device 112, and one or more sensors 114.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

As noted elsewhere, a media collection device may include one or more input device 112 as well as a number of sensors 114. An input device 112 may include any device capable of obtaining imagery and/or audio. For example, the input device may include a camera device capable of capturing image data and/or a microphone device capable of capturing audio data. In some embodiments, the input device may be configured to capture streaming media (audio and/or video) data to be provided to the media processing platform. In some embodiments, the input device may be configured to capture media, such as still images, at periodic intervals. In some cases, the captured media content may be stored locally on the media collection device and uploaded to the edge device when a communication channel is established between the two. In some cases, the captured media content may be transmitted to the edge device in real-time (e.g., as the media content is captured).

Each media collection device may include an input/output (I/O) interface 208 that enables interaction between the media collection device and a user (e.g., its wearer). Additionally, the media collection device may include a communication interface 210 that enables communication between the media collection device and at least one other electronic device (e.g., edge device 108 and/or the media processing platform). Such a communication interface may include some combination of short-range communication mechanisms and long-range communication mechanisms. For example, the media collection device may connect to one or more external devices in its proximity via a short-range communication channel (e.g., Bluetooth®, Bluetooth Low Energy (BLE), WiFi, etc.) and may connect to the media processing platform via a long-range communication channel (e.g., cellular network).

An edge device 108 may include any suitable computing device capable of receiving media content from one or more media collection device, indicating events detected with respect to the media collection device, and conveying the media content and indicated event data to the media processing platform. In accordance with various embodiments, an edge device may include at least one or more processors 212, a memory 214, and a communication interface 216.

The one or more processors 212 and the memory 214 of the edge device 108 may implement functionality from one or more software modules and data stores. Such software modules may include routines, program instructions, objects, and/or data structures that are executed by the processors 212 to perform particular tasks and/or implement particular data types. The memory 214 may include at least a module for detecting and classifying events detected within a media content (e.g., event detection engine 218). Additionally, the memory 206 may further include one or more database tables or other data storage schemas. The data storage schemas may include at least a database of event indicators associated with events that have been identified and classified (event indicator data 220).

The event detection engine 218 may be configured to, in conjunction with the processor 204, identify particular events that occur within a media content and to categorize and event indicator those events. In some embodiments, this comprises receiving media content from a media collection device as well as sensor data corresponding to that media content. An event may be identified based on data patterns detected within the sensor data. For example, given a scenario in which the media collection device is being operated by a law enforcement officer, the event detection engine may detect data patterns that indicate that the officer has become prone, has started running, has turned (or otherwise repositioned) suddenly, or performed another suitable action based on the received sensor data. An event may be generated for each of these detected actions/conditions.

Upon detecting an event associated with a piece of media content, the event detection engine 218 may generate an event indicator for that event. In some embodiments, the event indicator may be stored separate from the media content in a database of event indicator mappings (e.g., event indicator data 220). In some embodiments, the event indicator may be associated with the media content (e.g., as metadata or as a separate track) in a manner that indicates the beginning and/or end of the event within the media content. Once the event indicator has been generated for the event, the media content is provided to the media procession platform along with an indication of any identified event indicators/events. In some embodiments, an event indicator associated with an event may be updated or otherwise adjusted by a user (e.g., an administrator). For example, the user may adjust a begin or end time for the event. In some embodiments, certain generated event indicators within a media content may be flagged for user review based on a type of event associated with those event indicators.

In some embodiments, the event detection engine may use machine learning (ML) to perform event detection. In such embodiments, the event detection engine may be configured to, in conjunction with the processor 204, train a machine learning model to be used to identify and categorize events. In some embodiments, this may comprise generating training data in which a user simulates particular events while wearing, or otherwise operating, a media collection device. When the training data is provided to the ML model, the event may be identified manually in order to facilitate the ML model in correlating one or more patterns detected in the provided data with the event. The event detection engine may utilize any suitable algorithm for generating an appropriate trained machine learning model. For example, the event detection engine may use a deep learning algorithm that operates based on artificial neural networks with representation learning. In this example, a trained machine learning model may consist of a number of layers of which each layer includes mathematical relationships between various inputs and outputs for the model. In some embodiments, feedback received in relation to an accuracy of the trained machine learning model is used to adjust that model (e.g., by adjusting variables included within one or more layers of the trained machine learning model).

As noted elsewhere, the edge device may include a communication interface 216 that enables communication between the media collection device and at least one other electronic device (e.g., media collection device 102 and/or the media processing platform). Such a communication interface may include some combination of short-range communication mechanisms and long-range communication mechanisms. For example, the edge device may connect to one or more external devices in its proximity via a first communication 220 established over a short-range communication channel (e.g., Bluetooth®, Bluetooth Low Energy (BLE), WiFi, etc.) and may connect to the media processing platform via a second communication 222 established over a long-range communication channel (e.g., a cellular network).

The media processing platform 104 can include any computing device or combination of computing devices configured to perform at least a portion of the operations described herein. The media processing platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The media processing platform 104 can include one or more virtual machines running virtual operating systems, or other computing architectures involving virtualization such as one or more flexible pools of logical storage devices that can be virtualized to maintain virtual storage devices for the computer. For example, the media processing platform 104 may include virtual computing devices in the form of virtual machines or software containers that are hosted in a cloud.

The media processing platform 104 may include one or more processors 224, memory 226, a communication interface 228, and hardware 230. The communication interface 228 may include wireless and/or wired communication components that enable the media processing platform 104 to transmit data to, and receive data from, other networked devices. The hardware 230 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The one or more processors 224 and the memory 226 of the proxy device 108 may implement functionality from one or more software modules and data stores. Such software modules may include routines, program instructions, objects, and/or data structures that are executed by the processors 224 to perform particular tasks or implement particular data types. The memory 226 may include at least a module for managing the collection, storage, and use of media content (e.g., managing the media management engine 232). Additionally, the memory 226 may further maintain a data store 234 that includes one or more database tables. Particularly, the data store 234 may include a database of media content received from one or more media collection devices (e.g., media content 212) as well as a database of rules used to determine procedures to be applied to the media content (procedural rules 238).

In some embodiments, the media management engine 232 may be configured to, in conjunction with the processor 224, process media content in accordance with one or more policies maintained by the media processing platform. In some embodiments, the media management engine may be configured to apply one or more procedural rules to each of the media content 236, or portions thereof, based on event indicators associated with the media content. In some embodiments, retention rules for media content may be correlated to a ranking value or score determined for the media content. For example, an amount of time that the media content should be stored, or otherwise maintained, for may be determined based on one or more events associated with the respective media content. For example, media content having a higher determined ranking value may be retained for a longer period of time than media content having a lower determined ranking value. In some cases, one or more media content may be selected from the media content 236 to be presented to a reviewer or other operator. For example, a request may be submitted to the media management engine 232 for media content to be reviewed by a user. In this example, the media management engine 232 may select a media content having the highest-ranking value that has not yet been reviewed. That media content, or a link to a location in memory at which the media content is stored, may be provided to the originator of the request.

The communication interface 228 may include wireless and/or wired communication components that enable the media processing platform to transmit or receive data via a network, such as the Internet, to a number of other electronic devices (e.g., media collection device 102). Such a communication interface 202 may include access to both wired and wireless communication mechanisms. In some cases, the media processing platform transmits data to other electronic devices over a long-range communication channel, such as a data communication channel that uses a mobile communications standard (e.g., long-term evolution (LTE)).

The hardware 230 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

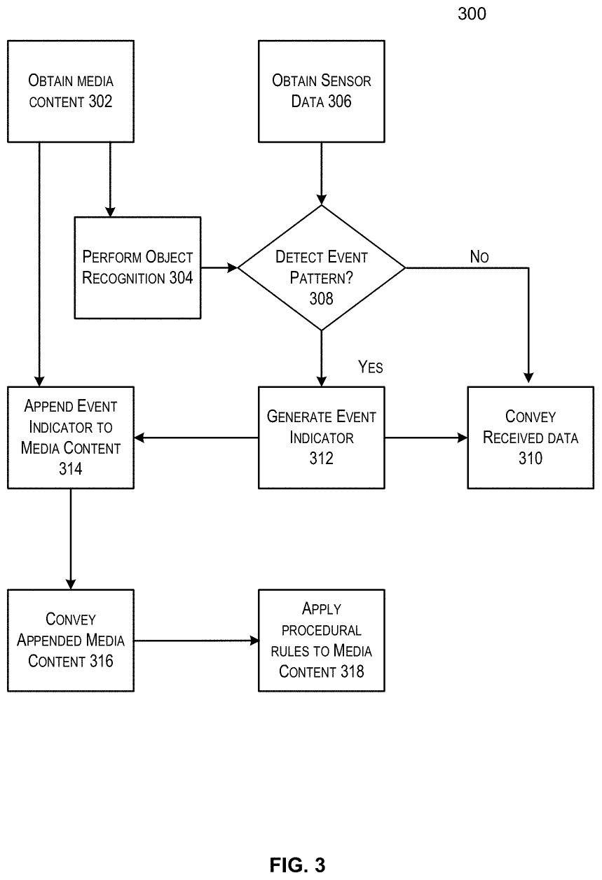

FIG. 3 depicts a block diagram showing an example process flow for identifying and indicating events within media content via one or more edge devices in accordance with embodiments. The process 300 involves interactions between various components of the architecture 100 described with respect to FIG. 1. More particularly, the process 300 involves interactions between at least a media processing platform 104, an edge device, and a media collection device 102.

At 302 of the process 300, media content is obtained from a media collection device. In some cases, the media content is received from a wearable device capable of being mounted on a person. In some cases, the media content is received from a camera device mounted within a vehicle. The media content may be received as a stream of content in real-time (substantially as the media content is obtained) via a communication channel maintained between the edge device and the media collection device. Alternatively, the media content may be uploaded all at once at a time subsequent to the collection of the media. For example, at the end of shift, a worker (e.g., a law enforcement officer) may upload a video captured over the course of the shift by his or her wearable media collection device to the edge device to be conveyed to the media processing platform.

In some embodiments, the process 300 may comprise performing one or more object recognition techniques at 304. For example, an object recognition technique may be employed to identify categories of objects that appear within a media content and at what times those respective objects appear within the media content. In some embodiments, when an object in a video or image is determined to be a face, an identification of the owner of that face may be provided. In some embodiments, one or more audio cues may be identified within audio data. For example, the object recognition technique may be used to detect particular spoken words or phrases within the media content.

At 306 of the process 300, sensor data is obtained by the media processing platform. In some cases, such sensor data is obtained from the same media collection device from which the media content is received at 302. For example, the sensor data may include information obtained from a gyroscope, accelerometer, compass or other suitable sensor device installed within the media collection device with respect to time.

At 308, a determination may be made as to whether one or more patterns of data that correspond to an event can be identified. In some cases, this comprises providing the received data to a trained machine learning model. Such a machine learning model may have been trained to draw correlations between patterns in sensor and/or contextual data and one or more events. In some embodiments, multiple machine learning models may be utilized. For example, a first machine learning model may be used to identify a context to be associated with a media content file and a second machine learning model may be used to identify events. In some cases, an administrator or other user may define events that are to be identified during a training process. In some embodiments, the trained machine learning model may determine, based on the provided sensor/contextual data, a likelihood that a particular event has occurred. The event may be detected (i.e., determined to have occurred) if the corresponding likelihood value is greater than a predetermined threshold.

In some cases, an event may be detected upon identifying one or more predefined data patterns within the sensor data. For example, the process may comprise conducting an analysis of the sensor data according to rules and/or tables of sensor data in order to identify data patterns corresponding to various events to be tracked. In these cases, an event indicator may be generated to indicate where, within the sensor data, the media processing platform should look for an event.

If the trained learning model does not detect any events (e.g., “No” from decision block 308) then the received data may be conveyed to the media processing platform at 310 without generating any event indicators. However, if the trained learning model determines that an event has occurred (e.g., “Yes” from decision block 308), then the process 300 comprises generating an event indicator at 312. For example, an event indicator may be generated for an event upon determining that the likelihood of that event having occurred is greater than a predetermined threshold. A generated event indicator may include any combination of an event identifier that uniquely identifies the event, an event categorization and/or text, or a timestamp/timestamp range. In some embodiments, an indication of the event may additionally be stored in a separate database (e.g., an event database) along with an indication of the media content to which the event indicator relates.

At 314 of the process 300, one or more generated event indicators is associated with the media content. In some embodiments, the generated event indicators are appended to the media content as metadata or within a separate data track. In some embodiments, the generated event indicators are stored in a database table or other storage medium that is correlated to the media content. At 316 of the process 300, the indicated media content is conveyed to the media processing platform. In some embodiments, the indicated media is stored in a manner that it is accessible to one or more users that wish to play the media content. In some embodiments, the media processing platform may also store an unindicated version of the media content (e.g., for evidentiary purposes).

In some embodiments, one or more users may be notified of the indicated media content. For example, certain events or event categories may be flagged for independent review by a user. In this example, each time that an event indicator is generated that corresponds to one of the events or event categories, a notification may be generated and provided to the user. The user may then be provided the ability to load the indicated portion of the media content that corresponds to the flagged event.

At 318, the process 300 may comprise applying one or more procedural rules to the media content based on event indicators/events associated with the media content. In some embodiments, this may comprise applying different retention rules to particular portions of a media content based on event indicators associated with the respective portions. For example, a first portion of the media content may be maintained/stored for three months whereas a second portion of the media content may be retained/stored for 18 months. In this example, the difference between the first portion of the media content and the second portion may be the different event types associated with the respective portion. In some embodiments, the procedural rules may indicate one or more types of event indicators/events that should be flagged for review by a reviewer. In these embodiments, portions of the media content associated with such event indicators may be provided to a reviewer to be reviewed. In some embodiments, a ranking value may be calculated based on one. In some embodiments, the media content may be provided to a reviewer in real-time (e.g., as the media content is received) upon detecting a particular event indicator type/ranking value.

It should be noted that while the process 300 is depicted as being performed by an edge device, at least a portion of the process 300 may be performed by another computing entity. For example, at least a portion of the process may be performed by a media collection device and/or the media processing platform instead of by the edge device.

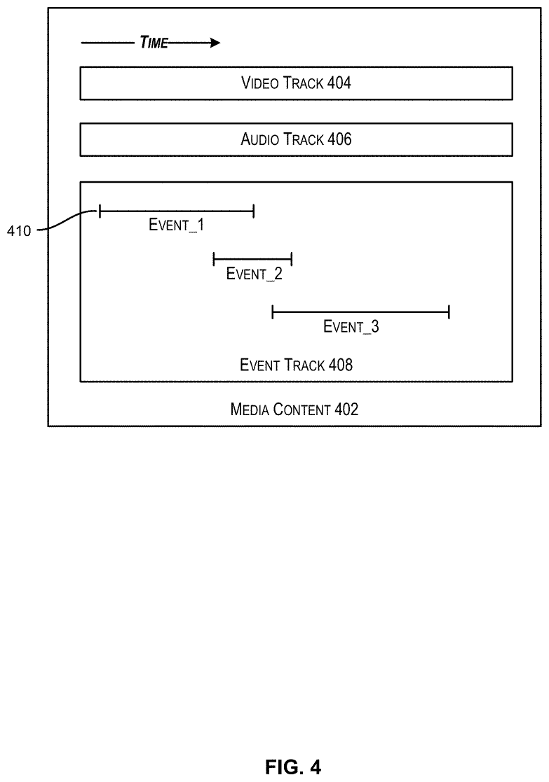

FIG. 4 depicts an example structure diagram for a media content file that may be generated to include indicated events in accordance with at least some embodiments. In some embodiments, a media content file 402 may include a number of tracks, each of which may include different types of data. For example, in the case that the media content file is a video file, that media content file may include at least a video track 404 and an audio track 406. In this example, a video track may include image data with respect to time whereas an audio track may include audio data with respect to time. Each of the tracks within the media content file may be correlated based on timestamps in each of the respective tracks.

A number of event indicators 410 may be associated with the media content file 402. In some embodiments, such event indicators for events (e.g., Event_1, Event_2, and Event_3) are appended to the media content within an event track 408 that comprises event indicator data (i.e., event indicators) with respect to time that correlates to each of the video track and audio track based on timestamps associated with the respective event indicator data.

In some embodiments, the event indicators included within an event track, or metadata as described in alternative embodiments, may include at least text data and timestamp data. In some cases, each of the event indicators in the event indicator data may include an indication of an event identifier that can be used to identify an event within a database table or other data storage means. In some embodiments, timestamp data stored in event data may include a single timestamp associated with the event. In some embodiments, timestamp data stored in event data may include a range of timestamp data. For example, the event indicators may include at least a beginning timestamp and an ending timestamp for the event. It should be noted that ranges of timestamp data for the event indicators in the event track can overlap in that the beginning timestamp for a second event can occur after the beginning timestamp of a first event but before the ending timestamp of the first event.

When the media content file is played using a suitable media player, the event data may be presented to the consumer of the media content along with the data in the other tracks. For example, text associated with the event indicators may be overlayed onto a video of a video track on a graphical user interface presented via the media player. In some embodiments, a list of event indicators identified within the event track may be presented to the consumer of the media such that the consumer is able to select one of the event indicators. Upon selection of an event indicator from the list of event indicators, the media player may move to a position within the media content that corresponds to the selected event indicator.

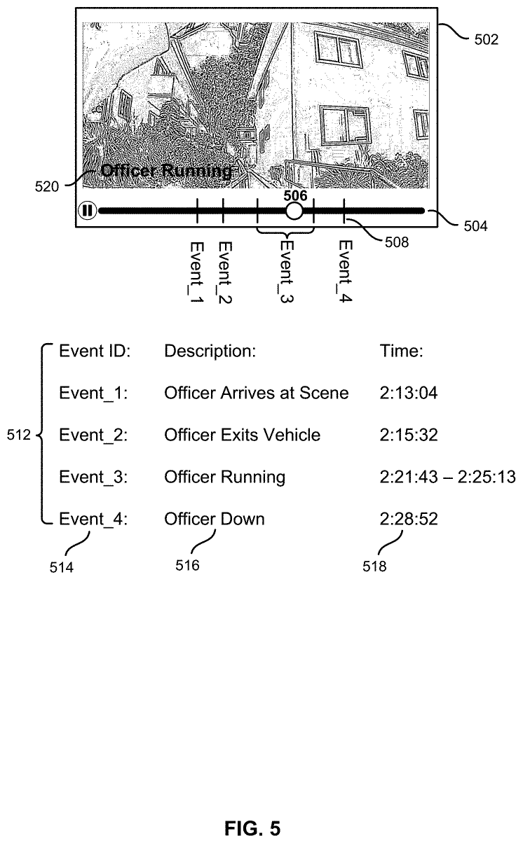

FIG. 5 depicts an example of a graphical representation of one or more interactions that may be undertaken with a media content file that has been indicated with one or more events in accordance with embodiments. In FIG. 5, a graphical user interface (GUI) 502 is depicted as being presented in association with a media player application. In the depicted example, the media player application is one configured to present media content, such as a video.

Each media content file may contain an associated timeline (e.g., a series of timestamps) that is used to synchronize various data tracks included within the media content file. The timeline may be presented via the GUI as a timeline bar 504. A timeline bar may include a position marker 506 that indicates a respective position of the current content within the timeline of the media content file. In some embodiments, a timeline bar may further include a number of time markers 508 that indicate relative positions within the timeline that are associated with event indicators for different events.

In some embodiments, a media content file may include an event track having event indicators 512 for a number of events associated with that media content file. As described elsewhere, such event indicators may be included within a data track of the media content file. In some embodiments, each of the event indicators may include an event identifier 514 that identifies a particular event, a categorization 516 or description, and a time 518. A categorization for an event may be determined using a trained machine learning model as described elsewhere. In some cases, the time 518 associated with an event indicator may be represented as a single point in time within a timeline included in a media content file. In some cases, the time 518 associated with an event indicator may be represented as a range of times within a timeline included in a media content file.

In some embodiments, at least a portion of the information associated with an event indicator may be presented within a GUI when the media content is played. For example, when a video (i.e., an example media content) is played, such a video may be overlayed with text 520 associated with an event indicator. In some embodiments, the GUI may cause a list of event indicators associated with the media content to be presented to the user and enable the user to select (e.g., by clicking on) one of the presented event indicators. In such embodiments, selection of a particular event indicator within the presented list of event indicators may cause the media player to play a portion of the video associated with that event indicator by skipping to a position within the video timeline that is associated with the event indicator. Such embodiments enable a user to quickly skip to portions of a video that might be relevant to the user's viewing interests without requiring the video to be viewed in its entirety.

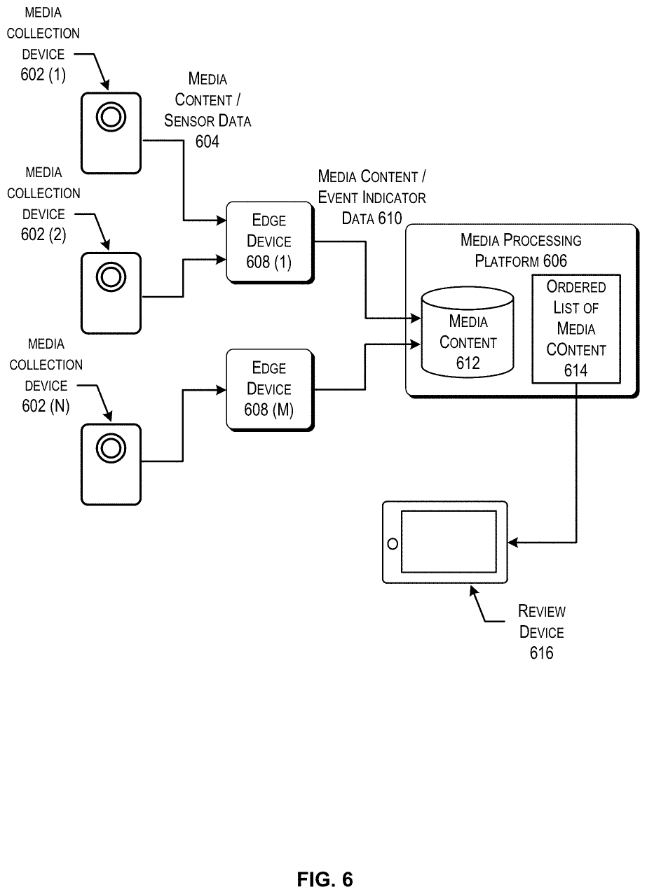

FIG. 6 depicts an illustrative example of a number of interactions that may take place in accordance with at least some embodiments. Particularly, the interactions may take place between one or more components of the computing environment 100 as described with respect to FIG. 1 above.

In some embodiments, a number of media collection devices 602 (1-N) may be operated throughout a geographic region. Each of the media collection devices is configured to capture media content and sensor data 604 to be provided to a media processing platform 606.

One or more edge devices 608 (1-M) may additionally be located throughout the region. The edge devices may be in communication with the media processing platform via a communication session established over a long-range communication channel. In some cases, the long-range communication channel may comprise a cellular network connection or other wireless communication channel. In some cases, the long-range communication channel may comprise a wired connection. The edge device may be in communication with the media processing platform via an Internet connection.

Each of the media collection devices may be in communication with one of the edge devices in its geographic proximity via a communication session established over a short-range communication channel. Each of the media collection devices may transmit its respective collected media content to an edge device in its proximity. The edge device may generate one or more event indicators to be associated with the media content based on events detected from the received sensor data. The edge device then transmits the media content and event indicator data 610 to the media processing platform via the long-range communication channel.

The media processing platform receives the media content and event indicator data from each of the edge devices. The received media content is stored in a database of media content 612 along with media content and event indicator data received from each of the other edge devices. In some embodiments, the media processing platform generates a ranking value for each of the received media content based on the event indicators associated with each media content or at least a portion of the media content. In some embodiments, the media processing platform may generate an ordered list of media content 614 that is ordered based on the ranking value determined for each of the media content.

In some embodiments, the media processing platform may provide a media content to a review device 616 to be reviewed by an operator of the device. The review device may include a media player application (e.g., a video player) that enables the media content (e.g., video data) to be played. In some embodiments, the review device may be provided media content as streaming video data in real time as it is collected by a respective media collection device. In some embodiments, the media content provided to the review device may be switched or changed as a ranking value for the respective media content changes (e.g., as a set of event indicators associated with the respective media content changes). In some embodiments, an operator of the review device may select the media content from the ordered list of media content. In some cases, the operator of the review device may be provided with an indication of a predetermined number of the media content having the highest-ranking values. For example, the operator of the review device may be provided with an indication of the five media content having the highest determined ranking value based on the event indicators associated with those ranking values.

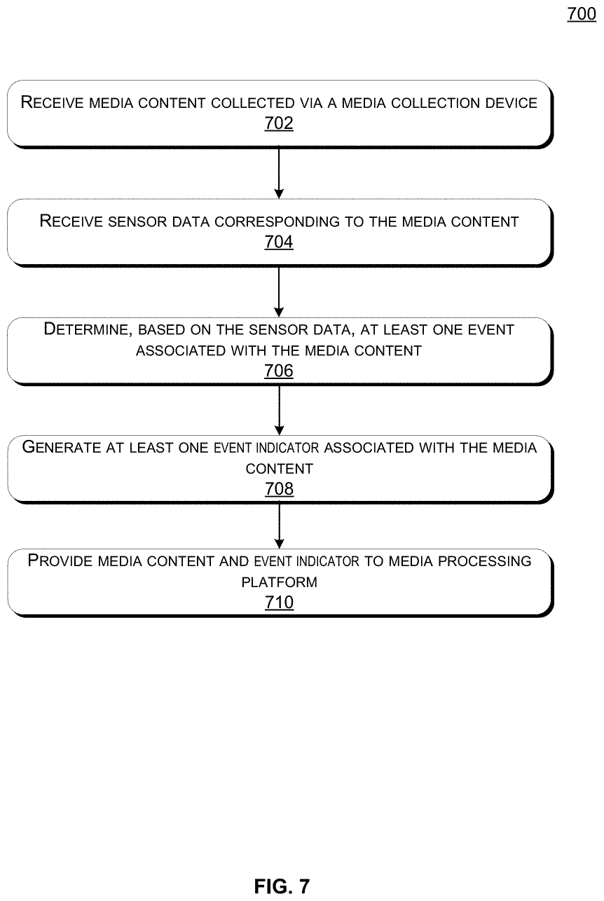

FIG. 7 depicts a block diagram showing an example process flow for automatically identifying and indicating events in a media content in accordance with embodiments. The process 700 may be performed by components within a system 100 as discussed with respect to FIG. 1 above. For example, the process 700 may be performed by an edge computing device 108 in communication with a media processing platform 104 and a number of media collection devices 102.

At 702, the process 700 comprises receiving media content from a media collection device. The media content may comprise any combination of audio data, video data or imagery data. In some embodiments, the media content comprises video data captured using a camera installed within the media collection device. In some embodiments, the media content is received from the media collection device in substantial real-time as streaming data. For example, the media content may comprise streaming video that is received from the media collection device as it is collected.

At 704, the process 700 comprises receiving sensor data corresponding to the received media content. In some embodiments, the sensor data comprises data obtained from at least one of a gyroscope, accelerometer, or magnetometer. The sensor data corresponding to the media content may be received from the same media collection device from which the media content is received.

At 706, the process 700 comprises determining, based on the received sensor data, at least one event associated with the media content. In some embodiments, the at least one event to be associated with the media content is determined based on one or more data patterns detected within the sensor data. In these embodiments, the one or more data patterns may be detected using a trained machine learning model.

At 708, the process 700 comprises generating at least one event indicator associated with the media content based on the at least one event. In some embodiments, the generated event indicator comprises at least one of an event identifier and a timestamp. In some cases, the timestamp represents a single point in time, whereas in other cases the timestamp represents a range of times.

At 710, the process 700 comprises providing the media content and event indicator to the media processing platform. In some embodiments, the generated event indicator is provided to the media processing platform within an event data track of the media content.

Upon receiving the media content and event indicator data, the media processing platform may process the media content by applying one or more procedural rules to the received media content based on the event indicator data.

In some embodiments, applying one or more procedural rules to the received media content may comprise applying one or more retention rules to the media content. For example, the media processing platform may be caused to store, or otherwise maintain, the received media content for an amount of time that is determined based on the event indicators associated with that media content. In some embodiments, different portions of a single media content may be stored for different amounts of time based on the event indicators associated with the respective portions. For example, a portion of a video file that is associated with an event indicator indicating that the operator of a media collection device is likely running may be stored longer than another portion of the video file in which the operator is likely not running. In some embodiments, some portion of the media content occurring a predetermined amount of time before or after an event may also be stored. For example, in addition to storing longer a portion of a video file in which the operator is likely to be running, the fifteen-minute portion of the video file proceeding that event may further be stored longer.

In some embodiments, applying one or more procedural rules to the received media content may comprise applying a review policy to the media content. For example, one or more media content may be provided to a reviewer (e.g., an administrator or other operator associated with the media processing platform) for review. In this example, the media processing platform may select a media content to be provided to the reviewer for review. In some embodiments, media content may be selected to be provided to a reviewer based on one or more types of events indicated as being associated with the media content via event indicators. In some embodiments, a ranking value is calculated for each media content, or various portions thereof, received by the media processing platform based on event indicators associated with the respective media content. For example, in some cases each event indicator type may be associated with a point value. In these cases, a ranking value may be calculated for a particular media content as the sum of each of the point values assigned to the events associated with the media content.

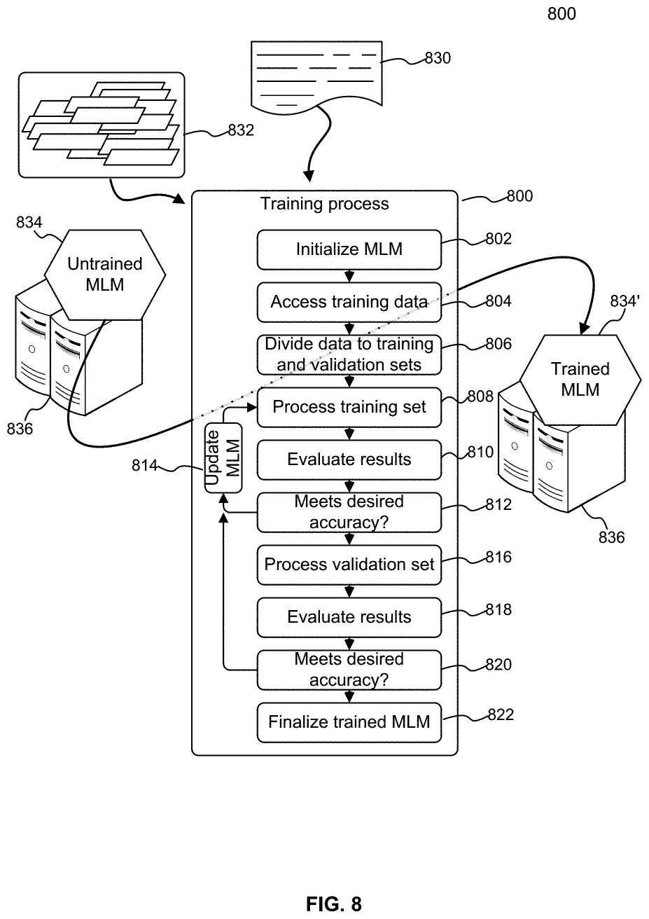

FIG. 8 illustrates an exemplary overall training process 800 of training a machine learning model, a trained machine learning model that may be used in an edge device, or by the media processing platform, to indicate events within media content according to sensor data, in accordance with aspects of the disclosed subject matter. Indeed, as shown in FIG. 8, the training process 800 is configured to train an untrained machine learning model 834 operating on a computer system 836 to transform the untrained machine learning model into a trained machine learning model 834′ that operates on the same or another computer system. In the course of training, as shown in the training process 800, at step 802, the untrained machine learning model 834 is optionally initialized with training features 830 comprising one or more of static values, dynamic values, and/or processing information.

At step 804 of training process 100, training data 832, is accessed, the training data corresponding to multiple items of input data. According to aspects of the disclosed subject matter, the training data is representative of a corpus of input data of which the resulting, trained machine learning model 834′ will receive as input. As those skilled in the art will appreciate, in various embodiments, the training data may be labeled training data, meaning that the actual results of processing of the data items of the labeled training data are known (i.e., the results of processing a particular input data item are already known/established). Of course, in various alternative embodiments, the corpus 832 of training data may comprise unlabeled training. Techniques for training a machine learning model with labeled and/or unlabeled data are known in the art.

With the training data 832 accessed, at step 806 the training data is divided into training and validation sets. Generally speaking, the items of input data in the training set are used to train the untrained machine learning model 834 and the items of input data in the validation set are used to validate the training of the machine learning model. As those skilled in the art will appreciate, and as described below in regard to much of the remainder of training process 100, in actual implementations there are numerous iterations of training and validation that occur during the overall training of the machine learning model.

At step 808 of the training process, the input data items of the training set are processed, often in an iterative manner. Processing the input data items of the training set include capturing the processed results. After processing the items of the training set, at step 810, the aggregated results of processing the input data items of the training set are evaluated. As a result of the evaluation and at step 812, a determination is made as to whether a desired level of accuracy has been achieved. If the desired level of accuracy is not achieved, in step 814, aspects (including processing parameters, variables, hyperparameters, etc.) of the machine learning model are updated to guide the machine learning model to generate more accurate results. Thereafter, processing returns to step 802 and repeats the above-described training process utilizing the training data. Alternatively, if the desired level of accuracy is achieved, the training process 100 advances to step 816.

At step 816, and much like step 808, the input data items of the validation set are processed, and the results of processing the items of the validation set are captured and aggregated. At step 818, in regard to an evaluation of the aggregated results, a determination is made as to whether a desired accuracy level, in processing the validation set, has been achieved. At step 820, if the desired accuracy level is not achieved, in step 814, aspects of the in-training machine learning model are updated in an effort to guide the machine learning model to generate more accurate results, and processing returns to step 802. Alternatively, if the desired level of accuracy is achieved, the training process 100 advances to step 822.

At step 822, a finalized, trained machine learning model 834′ is generated. Typically, though not exclusively, as part of finalizing the now-trained machine learning model 834′, portions of the now-trained machine learning model that are included in the model during training for training purposes may be extracted, thereby generating a more efficient trained machine learning model 834′.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving via a short-range communication channel, at an edge device, a media content having been collected by a media collection device;
receiving, at the edge device, sensor data corresponding to the media content;
determining, based on one or more data patterns detected within the received sensor data, at least one event corresponding to the one or more data patterns to be associated with the media content;
generating at least one event indicator to be associated with the media content based on the determined at least one event; and
transmitting via a long-range communication channel, at the edge device, the media content and the at least one event indicator to a media processing platform.

2. The method of claim 1, wherein the media content comprises video data captured using a camera installed within the media collection device.

3. The method of claim 2, wherein the media content is received from the media collection device in substantial real-time as streaming data.

4. The method of claim 1, wherein the sensor data comprises data obtained from at least one of a gyroscope, accelerometer, or magnetometer.

5. The method of claim 1, further comprising retaining the media content for an amount of time determined in accordance with the set of retention rules.

6. The method of claim 1, further comprising providing the media content to a reviewer if one or more conditions of the set of review rules are met.

7. The method of claim 6, further comprising determining a ranking value for the media content based on the at least one event indicator, wherein one or more conditions of the set of review rules are met upon the ranking value being greater than a threshold ranking value.

8. A computing device comprising:
a processor;
a communication interface that enables communication in short-range communication channel and a long-range communication channel; and
a memory including instructions that, when executed with the processor, cause the computing device to, at least:
receive via the short-range communication channel, at the communication interface, a media content having been collected by a media collection device;
receive sensor data corresponding to the media content;
determine, based on one or more data patterns detected within the received sensor data, at least one event corresponding to the one or more data patterns to be associated with the media content;
generate at least one event indicator to be associated with the media content based on the determined at least one event; and
transmit via the long-range communication channel, at the communication interface, the media content and the at least one event indicator to a media processing platform.

9. The computing device of claim 8, wherein the generated event indicator comprises at least one of an event identifier and a timestamp.

10. The computing device of claim 9, wherein the timestamp represents a single point in time.

11. The computing device of claim 9, wherein the timestamp represents a range of times.

12. The computing device of claim 8, wherein the generated at least one event indicator is provided within an event data track of the media content.

13. The computing device of claim 8, wherein the media content is received from the media collection device in substantial real-time as streaming data.

14. The computing device of claim 8, wherein the one or more data patterns is detected using a trained machine learning model.

15. The computing device of claim 8, wherein the sensor data corresponding to the media content is received from the media collection device.

16. The computing device of claim 8, wherein the media content comprises a combination of audio data, video data or imagery data.

17. The computing device of claim 8, wherein the instructions further cause the computing device to determine a ranking value for the media content based on the at least one event indicator.

18. A non-transitory computer-readable media collectively storing computer-executable instructions that upon execution cause one or more computing devices to collectively perform acts comprising:
receiving via a short-range communication channel a media content having been collected by a media collection device;
receiving sensor data corresponding to the media content;
determining, based on one or more data patterns detected within the received sensor data, at least one event corresponding to the one or more data patterns to be associated with the media content;
generating at least one event indicator to be associated with the media content based on the determined at least one event; and
transmitting via a long-range communication channel the media content and the at least one event indicator to a media processing platform.

19. The computer-readable media of claim 18, wherein the acts further comprise retaining the media content for an amount of time determined in accordance with the set of retention rules.

20. The computer-readable media of claim 19, wherein the acts further comprise providing the media content to a reviewer if one or more conditions of the set of review rules are met.
